(19) United States
(12) Patent Application Publication
(10) Pub. No.: US 2007/0283702 A1
(43) Pub. Date: Dec. 13, 2007

(54) Dual heat to cooling converter

(76) Inventor: Richard J. Strnad, Plano, TX (US)

Correspondence Address: Richard J. Strnad, 2524 Preston Rd., #204, Plano, TX, 75093, US

(21) Appl. No.: 11/123,346

(22) Filed: May 6, 2005

(51) Int. Cl. F25B 21/02; H02N 10/00

(52) U.S. Cl. 62/3.2; 310/306

(57) ABSTRACT

The dual heat to cooling converter is comprised of one device which converts thermal energy to electricity and the second device which converts electrical energy to cooling. The emf generating device may be of the thermoelectric type and the cooling device of the thermionic type and conversely, the emf generating device may be of the thermionic type and the cooling device may be of the thermoelectric type. The unwanted heat generated during the conversion process is removed by the adiabatic plane, located between the emf generator and the cooling generator. The emf generator and the cooling generator and thermally isolated and electrically connected.

This application relates to Provisional Patent Application titled “Thermal Energy Bi-Converter” filed on May 6, 2004 (Copy included). Application Number not received.

### FIELD OF THE INVENTION

This invention relates to a cooling apparatus, and in particular to a heat energy to cooling converting device.

### RELATED ART

“Heating” and “cooling” are terms used to describe the absorption and emission of heat from a substance. When substance is absorbing thermal energy it is heated and when substance is expelling thermal energy it is cooled. The heat removing process or cooling is called an exothermic event and the heat absorbing process is called an endothermic event. Heating is relatively easy to achieve, cooling is more difficult.

Cooling is conventionally accomplished through gas-liquid compression cycles using fluid type refrigerants to implement the heat transfer. Such systems are used extensively for cooling homes, transportation vehicles, perishable items or electromechanical systems. Although these systems are well established, a new cooling system presented in this application offers a viable replacement. A unique concept integrates the Seebeck and Peltier devices into one and converts heat energy directly to cooling.

Thermoelectric energy conversion is the interconversion of thermal and electrical energy for power generation and cooling and is based on the Seebeck and Peltier effects. More recently, some scientists have attempted to put to use the avalanche breakdown effect, the tunneling effect, and the Fowler-Nordheim tunneling thermionic effect to increase conversion efficiency by introducing virtual electrical gaps and mechanical microgaps within the material involved. In the early 1950's, progress in solid-state physics and chemistry led to the development of semiconductor thermoelements with the result that reasonably efficient thermoelectric devices could be constructed. Metallic thermoelectric devices provide only very low efficiencies, the most favorable being combinations of bismuth and antimony, which provide efficiencies of ca 1%, selected semiconductors can provide efficiencies of ca 8-10%.

The technique of direct energy conversion is characterized by the absence of moving parts, high reliability, quietness, lack of vibration, low maintenance and absence of pollution problems. Thermoelectric generators have been used increasingly in specialized applications in which combinations of their desirable features outweigh their high cost and low generating efficiencies, which are typically ca 3-7%. Large scale thermoelectric generators cannot compete with oil-fired central power stations, which operate at efficiencies of 35-40%. The most advanced thermoelectric systems are the radioisotope thermoelectric generators (RTGs), which have been developed for military and commercial systems under the aegis of DOE. Other thermoelectric generators were employed in space, in floating and terrestrial weather stations, cardiac pacemakers, and navigational buoys. Some other applications include power generation in remote navigational lights, communication line repeaters, and cathodic protection, e.g. protection of the east-west pipeline across Saudi Arabia by 34 thermoelectric stations.

The conversion efficiency of a thermoelectric generator and the coefficient of performance of a thermoelectric refrigerator depends upon the properties of the technologies are established; these are bismuth telluride, lead telluride, and the Si—Ge thermoelectric materials as expressed by their figure of merit. The development of solid state materials with enhanced figures of merit is in progress.

Thermionic energy conversion method involves heat energy conversion to electric energy by thermionic emission. In this process, electrons are thermionically emitted from the surface of a metal by heating the metal. Thermionic conversion does not require an intermediate form of energy or a working fluid, other than electric charges, in order to change heat into electricity. Thermionic energy conversion is based on the concept that a low electron work function cathode in contact with a heat source will emit electron. These electrons are absorbed by a cold, high work function cathode and they can flow back to the cathode through an external load where they perform useful work. From a physics standpoint, thermoelectric devices are similar to thermionic devices. In both cases a temperature gradient is placed upon a metal or semiconductor, and both cases are based upon the concept that electron motion is electricity. However, the electron motion also carries energy. In order to increase the power density, Kucherov describes in U.S. Pat. No. 6,396,191 B1 a thermionic semiconductor diodes with a gap between the n and p or metallic regions which enhances performance.

Energy conversion technique, U.S. Pat. No. 6,281,514 B1 described by Tafkhelidze, is related and is involving tunneling of electrons. In closely spaced materials electrons can tunnel from one material to the next, carrying their heat with them. With the addition of a voltage bias, which helps keep the electrons flowing in one direction, the heat is then transferred from one side to the other. Because the two sides are separated by a gap the heat cannot easily flow back. The claimed efficiency is in excess of 55% of Carnot efficiency, compared to 5-8% for thermoelectrics.

### SUMMARY OF THE INVENTION

The present invention combines electricity generating device and cooling device into one. A heat to electricity generator is used in conjunction with electricity to cooling converter. Although variety of devices can fulfill these functions, a pair of thermoelectric devices will be highlighted here for trivialization.

As a result of this invention a new type of device has been devised, converting thermal energy directly to cooling. The electricity generator and the cooling device are separated by an adiabatic wall and both devices are in thermal equilibrium with each other. The adiabatic wall also provides electrical connection between the two devices. The small distance between the devices is minimizing the electrical resistance thus guaranteeing maximum power transfer from device to device.

The inventor recognizes that the unique structure of the device does not require both devices to be made of same material when thermoelectric materials are involved. For example, one device can be made of P or N type lead telluride or Si—Ge alloy, while the second device can be made of P or N type bismuth telluride. This arrangement will be better suited in applications, where higher temperatures are involved and which exceed the safe operating temperature of bismuth telluride.

A further object of the present invention is to remove excessive heat generated by both devices. The heat removal is accomplished through the adiabatic cooling plane. Circulating fluid or gas in hollow plane removes unwanted heat and provides critical function in the operation of the device.

A further object of the invention is to design the adiabatic wall with smallest electrical resistance and highest heat removing effectiveness. Low electrical resistance is essential to minimize electrical energy transport losses and the contact area of the adiabatic wall with the fluid or gas must be optimized for maximum heat extraction.

These and other features of the invention will be more clearly understood and appreciated upon considering the detailed embodiments described hereinafter.

### BRIEF DESCRIPTION OF THE DRAWINGS

These and other aspects, features and advantages, the sophistication, as well as methods, operation, functions and related elements of structure, and significance of the present invention will become apparent in light of the following detailed description of the invention and claims, as illustrated in the accompanying drawings.

FIG. 1 is a drawing of heat to cooling converter with all components identified;

FIG. 2 is a profile of assembled heat to cooling converter showing all discrete members;

FIG. 3 is a profile drawing of all discrete components;

FIG. 4 is a circuit diagram showing connections of individual components;

FIG. 5 is a drawing of assembled heat to cooling converter;

FIG. 6 is a drawing of assembled heat to cooling converter identifying temperatures of each component;

FIG. 7 is showing assembled heat to converter illustrating cooling action of the device;

### DETAILED DESCRIPTION OF THE INVENTION

Creation and operation of structures utilizing the cooling action and electricity action of thermoelectric and thermionic devices are discussed at length in the literature, hereby incorporated by reference.

The present invention relates to a heat to cooling converter utilizing the thermoelectric or thermionic cooling component and utilizing the thermoelectric or thermionic component. Since both devices appear visually identical, only the thermoelectric devices will be shown fore easier identification.

According to the Peltier Effect, current passed through the device will result in absorption of heat at one end, and emission of heat at the other end. According to Seebeck Effect, a heat applied to one end of the device with constant temperature maintained at the opposite end will produce a voltage across the device, called the Seebeck voltage.

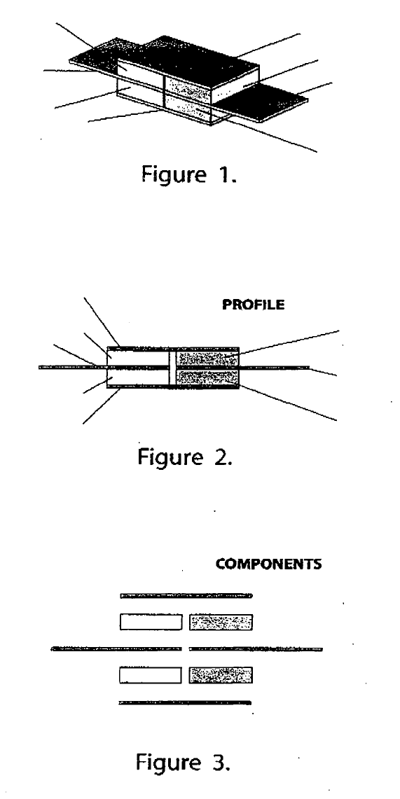

FIG. 1 shows an example of a device converting heat to cooling. Items 101, 102, 106, 103 and 108 represent in this example the electric power generating device, i.e. the Seebeck device. Items 108, 104, 107, 105 and 101 represent the cooling generator, in this example the Peltier cooling device.

FIG. 2 illustrates a profile of a device converting thermal energy to cooling. This picture indicates that the adiabatic conductive planes 101 and 108 are not electrically connected.

FIG. 3 shows individual components. When thermoelectric elements are used in construction, components 101 and 108, the adiabatic planes, are made of highly conductive, electrically and thermally, material. Components 102 and 104 are made of thermoelectric material, in this illustration semiconductor of n-type, and components 103 and 105 are made of semiconductor material of p-type. Elements 106 and 107 are electrically conductive strips of very low electrical resistance.

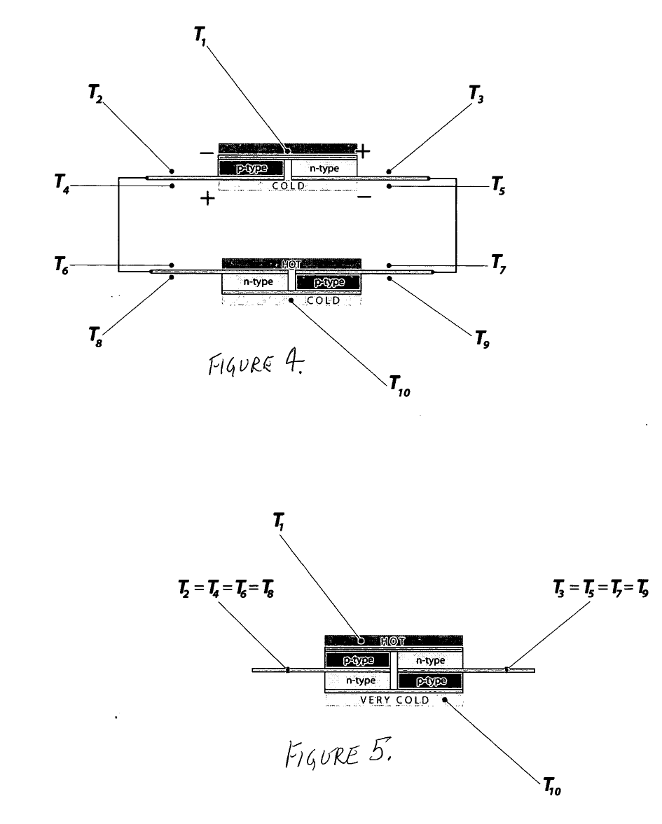

FIG. 4 illustrates the electrical connections between the electricity generator and the cooling generator. When thermal gradient is introduced across the Seebeck device, an emf is produced. This emf is transferred to the Peltier cooling generator which generates the cooling effect. It is important to realize, that the temperatures T₂=T₄=T₆=T₈ and the temperatures T₉=T₇=T₅=T₃ are maintained equal and constant to minimize the transfer losses.

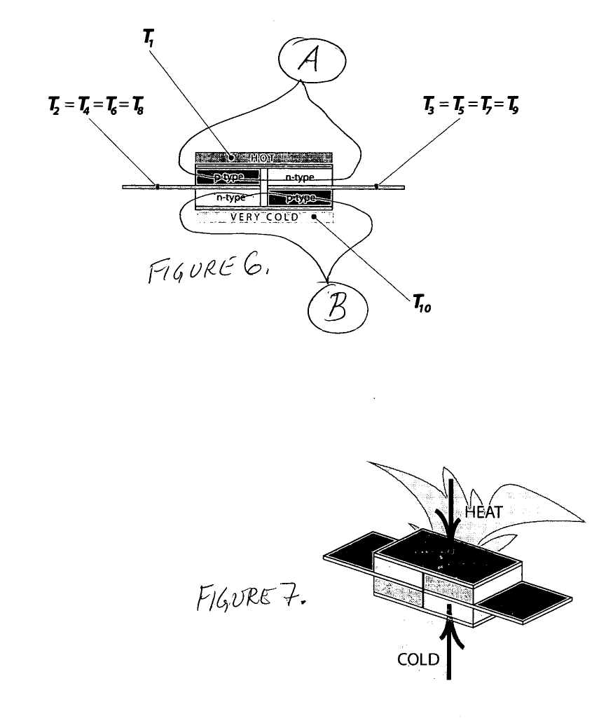

FIG. 5 shows that the adiabatic planes T_{2,3,4,5,6,7,8,9} should be maintained at constant temperatures. Temperature T₁ represents the temperature applied to the electricity generators, in this case to the Seebeck cell, and this temperature differs from the temperatures of the adiabatic planes. Temperature T₁ is usually higher than the temperature of the adiabatic plane. Temperature T₁₀ is produced by the cooling cell, in this case the Peltier effect device. Temperature T₁₀ is usually much lower than the temperatures of the adiabatic planes.

FIG. 6 shows a situation, when the thermoelectric cells of device “A” may be of different kind than the cell “B”. For example, the emf generator may be of the thermoionic type, and the “B” type cooling generator may be of thermoelectric type.

FIG. 7 is an isometric view of the cooling device. Dual endothermic effects on both sides of the generator absorb heat on one side and this thermal energy is transformed to electricity. The heat absorbed on the opposite side creates the cooling effect. The heat absorbed on both sides is then removed by the adiabatic plane. The plane may be hollow and internally cooled.

What is claimed is:

1. An apparatus converting heat to cooling comprising:
a first device converting thermal energy to electricity;
a second device converting electrical energy to cooling;
a structure connected thermally and electrically to both devices and transporting undesired and excessive thermal energy from the first and the second device to external storage or to heat dispersing device;

2. The structure as in claim 1, wherein each of said converting devices includes a hot region, warm region and a cold region, wherein said warm region is common to both devices;

3. The structure as in claim 1, wherein each of said converting devices comprises:
a first type of thermoelectric material generating electricity
a second type of thermoelectric material converting electricity to cooling;

4. The structure as in claim 1, wherein each of said converting devices comprises:
a thermionic device generating electricity; and
a thermoelectric device converting electricity to cooling;
a thermoelectric device generating electricity; and
a thermoelectric device converting electricity to cooling;

5. The structure as in claim 1, where the common adiabatic plane is hollow with substance transporting heat to outside location;
